(19) United States
(12) Patent Application Publication
(10) Pub. No.: US 2021/0111836 A1
(43) Pub. Date: Apr. 15, 2021

(54) BLOCK ACKNOWLEDGEMENT RECEPTION WINDOW SIZE FOR EHT NETWORKS

(71) Applicants: Po-Kai Huang, San Jose, CA (US); Daniel F. Bravo, Hillsboro, OR (US); Danny Alexander, Neve Efraim Monoson (IL); Danny Ben-Ari, Tsur Natan (IL); Arik Klein, Givaat Shmuel (IL); Amir Hitron, Beit Ytzhak (IL); Ofer Schreiber, Kryat Ono (IL); Laurent Cariou, Portland, OR (US)

(72) Inventors: Po-Kai Huang, San Jose, CA (US); Daniel F. Bravo, Hillsboro, OR (US); Danny Alexander, Neve Efraim Monoson (IL); Danny Ben-Ari, Tsur Natan (IL); Arik Klein, Givaat Shmuel (IL); Amir Hitron, Beit Ytzhak (IL); Ofer Schreiber, Kryat Ono (IL); Laurent Cariou, Portland, OR (US)

(21) Appl. No.: 17/129,388

(22) Filed: Dec. 21, 2020

Related U.S. Application Data
(60) Provisional application No. 62/976,691, filed on Feb. 14, 2020.

(51) Int. Cl. H04L 1/16; H04L 5/00; H04W 88/10

(52) U.S. Cl. CPC H04L 1/1621; H04L 1/1614; H04W 88/10; H04L 1/1642; H04L 5/0055

(57) ABSTRACT

An extremely high throughput (EHT) device configured for operation in an EHT network may negotiate a block acknowledge (BA) agreement with another EHT device including negotiate a maximum size of a receive reordering buffer to be up to one-third of sequence number (SN) space The SN space may have a predetermined maximum number of 4096 entries and may be signaled by twelve bits. When a larger reordering buffer is needed, the EHT STA may be configured to negotiate a larger reordering buffer size and additional SN space and may be configured to add additional signalling bits to signal the additional SN space.

### PRIORITY CLAIM

This application claims priority under 35 USC 119(e) to U.S. Provisional Patent Application Ser. No. 62/976,691, filed Feb. 14, 2020 [reference number AC8011-Z] which is incorporated herein by reference in its entirety.

### TECHNICAL FIELD

Embodiments pertain to wireless communications. Some embodiments relate to wireless local area networks (WLANs), Some embodiments relate to WLAN communications in accordance with the IEEE 802.11be draft standard (i.e., Extremely High Throughput (EHT)). Some embodiments relate to multi-link operation and block acknowledgement (BA) in EHT networks.

### BACKGROUND

One issue with WLANs is that the size of the receive reordering buffer is limited based on a number of signalling bits. This is particularly an issue an EHT networks, and more particularly with multi-link device (MLD) operation.

### BRIEF DESCRIPTION OF THE DRAWINGS

FIG. 1 illustrates block acknowledgement (ACK) (BA) architecture in accordance with some embodiments.

FIG. 2 illustrates a receive reordering buffer range in accordance with some embodiments.

FIG. 3 illustrates multi-link device operation in accordance with some embodiments.

FIG. 4 illustrated block ACK architecture for multi-link devices (MLDs) in accordance with some embodiments.

FIG. 5 illustrates MLD operation with link aggregation in accordance with some embodiments.

FIG. 6A illustrates issues with MLD operation in accordance with some embodiments.

FIG. 6B is a table illustrating various BA sizes in accordance with some embodiments,

FIG. 7 illustrates two scenarios with respect to BA window movement in accordance with some embodiments.

FIG. 8 illustrates signalling for BA starting sequence control and BA bitmap in accordance with some embodiments.

FIG. 9 is a functional block diagram of an EHT STA in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to an extremely high throughput (EHT) device configured for operation in an EHT network. In these embodiments, the EHT device may negotiate a block acknowledge (BA) agreement with another EHT device including negotiate a maximum size of a receive reordering buffer to be up to one-third of sequence number (SN) space. In these embodiments, the SN space may have a predetermined maximum number of 4096 entries and may be signaled by twelve bits. These embodiments are described on more detail below.

In some embodiments, when a larger reordering buffer is needed, the EHT STA may be configured to negotiate a larger reordering buffer size and additional SN space and may be configured to add additional signalling bits to signal the additional SN space. These embodiments are described in more detail below.

In some embodiments, the additional signalling bits may be defined within an expanded block ACK starting sequence number control field including an expanded starting sequence number field with a size equal to the twelve bits plus the additional required signalling bits. In some embodiments, the additional signalling bits may be defined within an existing block ACK starting sequence number control field including an expanded starting sequence number field with a size equal to the twelve bits plus the additional required signalling bits. These embodiments are described in more detail below.

In some embodiments, for a maximum negotiated size Y of the receive reordering buffer and a maximum size X of a block ACK bitmap, where Y<=X, the EHT STA may be configured to designate at least max (12, ceil(log 2(Y*3))) bits to indicate the SN range. These embodiments are described in more detail below.

In some embodiments, the SN space may comprise a sliding window in the memory corresponding to a maximum buffer size that is to include the receive reordering buffer of the negotiated size, a discard range and a moving range. In some embodiments, the discard range and the moving range may have a size equal to the negotiated size of the receive reordering buffer. These embodiments are described in more detail below.

In some embodiments, the device may be a multi-link device (MLD) (e.g., either an access point (AP) MLD or non-AP MLD) and may be configured for multi-link operation. In these embodiments, two or more links may be aggregated in which each of the aggregated links using a same traffic identify (TID). These embodiments are described in more detail below.

In some embodiments, when the MLD is operating as a recipient device and has negotiated the BA agreement with a originating MLD, the EHT device may allocate a portion of the memory to the SN space and decode received A-MPDUs from an originator device over two or more of the links, each MPDU having a sequence number (SN). In these embodiments, the EHT device may reorder the decoded MPDUs in the receive reordering buffer within the SN range and may encode a block ACK bitmap for transmission to the originator device, a size of the block ACK bitmap corresponding to be up to a maximum of the size of the receive reordering buffer. These embodiments are described in more detail below.

In some embodiments, the device is a station (STA) configured to operate as a non-multi-link device (MLD). These embodiments are described in more detail below.

There has been discussion on the largest buffer size that can be negotiated among two multi-link devices (MLDs) or two extreme high throughput (EHT) station devices (STAs). The buffer size that are under discussion are 512, 1024, 2048, and 4096. Note that the current largest buffer size supported by 11ax is 256.

One or more simulations have shown that under one link operation or multi-link aggregation with one queue implementation, then 512/1024 BA size is enough to get most of the gains. However, for multi-link aggregation with two queue implementation.

It is assumed that the MPDUs between queues do not move, and there is another wireless station contending for each link (N=2), then a larger BA buffer size is needed, like 4096 to compensate for the loss of FIFO property. The intuition is that during the time period that nothing can be transmitted due to constraint of block acknowledgment (BA) window, a large BA buffer window can enable more transmissions and increases the overall throughput.

However, a larger buffer size like 2048 and 4096 may not be supported by the current SN space range. Specifically, only 12 bits are available for the indication of SN. As a result, if a buffer size of 2048 is desired, there is only range of 2048 left for discarding range and moving range. If a buffer size of 4096 is desired, there is no range left for discarding range and moving range. This potentially enlarge the SN space range by adding more bits, but the rule of the discarding range and moving range needs to be addressed as well.

Various companies have proposed to increase the sequence number space by adding more bits. It was proposed using FN bits or new extension to increase the bits to accommodate higher SN range. In previous solutions, it is assumed that for a buffer size X, it may be needed to have SN space range of 2X. However, this assumption means that there is only a range X for both moving window and discarding window.

In one embodiment, an enhanced BA window and SN range system may facilitate that the SN range needs to be at least 3 times of the WinSizeB, which is the smaller of the BitmapLength, i.e., the maximum block ack bitmap of a negotiated buffer size and negotiated buffer size of a block ack agreement. As a result, discarding range can be the same as the WinSizeB, and moving range can be the same as the WinSizeB as well.

In the case of negotiated buffer size 2048 and maximum block ack bitmap size 2048, then one will need one more bit to the existing 12 bits sequence number indication. In the case of negotiated buffer size 4096 and maximum block ack bitmap size 4096, then one will need two more bits to the existing 12 bits sequence number indication.

In general, for a negotiated buffer size and maximum block ack bitmap size X, one will need log 2(X)+2 bits.

Given that the number of bits depending on the negotiated buffer size, one can have a dynamic method to determine the required additional bit for a negotiated TID between an originator and a recipient.

By having sufficient space for discarding range and moving range, the duplicate detection capability and the capability to move the receive reordering buffer with data frame will not be sacrificed.

Given that one may need 1 or 2 additional bits, the dynamic method can minimize the limitation of reusing the bits of existing fields like FN.

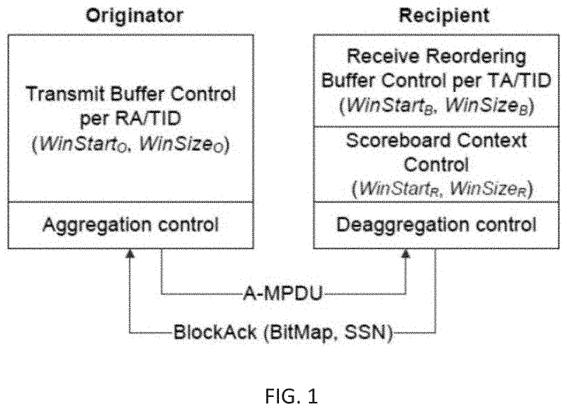

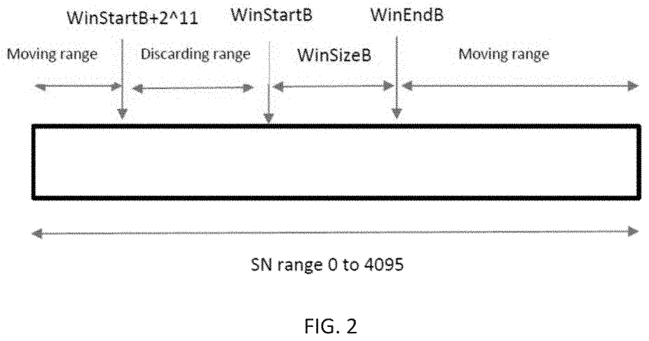

The current block ack architecture in IEEE 802.11revmd is shown in FIG. 1. There is a receive reordering buffer control on the recipient side with size WinSizeB. WinStartB and WinSizeB determines the range of receive reordering buffer in the range of sequence number space, which is 0 to 4095 due to usage of 1 bits for sequence number. When there is a MPDU with SN arriving before or after the receive reordering buffer range, the MPDU is discarded or the receive reordering buffer moves. We call the range that causes the MPDU to be discarded the discarding range. We call the range that causes the receive reordering buffer to be moved the moving range. Note that the calculation of range is based on modulo 4096. An example is shown in FIG. 2.

The detailed operation in revmd spec is shown below.

10.25.6.6.2 Operation or Each Received Data Frame
b) If WinEnd_{B}<SN<WinStart_{B}+2¹¹.
   1) Store the received MPDU in the buffer, if no MSDU with the same sequence number is already present: otherwise discard the MPDU.
   2) Set WinEnd_{B}=SN
   3) Set WinStart_{B}=WinEnd_{B}−WinSize_{B}+1.
   4) Pass any complete MSDUs or A-MSDUs stored in the buffer with Sequence Number subfield values that are lower than the new value of WinStart_{B} up to the next MAC process in order of increasing Sequence Number subfield value. Gaps may exist in the Sequence Number subfield values of the MSDUs or A-MSDUs that are passed up to the next MAC process.
   5) In a non-DMG STA, pass MSDUs or A-MSDUs stored in the buffer up to the next MAC process in order of increasing value of tire Sequence Number subfield starting with WinStart_{B} and proceeding sequentially until there is no buffered MSDU or A-MSDU for the next sequential Sequence Number subfield value. For a DMG STA, follow rules defined in item a) 2) above.
   6) Set WinStart_{B} to the Sequence Number subfield value of the last MSDU or A-MSDU that was passed up to the next MAC process plus one.
   7) Set WinEnd_{B}=WinStart_{B}+WinSize_{B}−1.
c) If WinStart_{B}+2¹¹≤SN<WinStart_{B}, discard the MPDU (do not store the MPDU in the buffer, and do not pass the MSDU or A-MSDU up to the next MAC process).

The same discarding range for block ack request (BAR) is used in the spec as shown below, and everything beyond the discarding is the range to move the receive reordering buffer using SSN of BAR.

10.25.6.6.3 Operation for Each Received BlockAckReq
a) If WinStart_{B}<SSN<WinStart_{B}+2¹¹,
   1) In a block ack agreement that is not a protected block ack agreement, set WinStart_{B}=SSN. See 10.25.8 (Protected block ack agreement) for a protected block ack agreement.
   2) Set WinEnd_{B}=WinStart_{B}+WinSize_{B}−1.
   3) Pass any complete MSDUs or A-MSDUs stored in the buffer with Sequence Number subfield values that are lower than the new value of WinStart_{B} up to the next MAC process in order of increasing Sequence Number subfield value. Gaps may exist in the Sequence Number subfield values of the MSDUs or A-MSDUs that are passed up to the next MAC process.
   4) Pass MSDUs or A-MSDUs stored in the buffer up to the next MAC process in order of increasing Sequence Number subfield value starting with SN=WinStart_{B} and proceeding sequentially until there is no buffered MSDU or A-MSDU tor the next sequential Sequence Number subfield value.
   5) Set WinStart_{B} to the Sequence Number subfield value of the last MSDU or A-MSDU that was passed up to the next MAC process phis one.
   6) Set WinEnd_{B}=WinStart_{B}+WinSize_{B}−1.
b) If WinStart_{B}+2¹¹≤SSN<WinStart_{B}, do not make any changes to the receive reordering buffer record.

The full state operation for scoreboard context control also follows similar range definition. The discarding range is essentially the no update range, and the moving range moves the scoreboard context control rather than receive reordering buffer.

[symbol]

10.25.6.3 Scoreboard Context Control During Full-Stale Operation
2) If WinEnd_{B}<SN<WinStart_{B}+2¹¹.
   i) Set to 0 the bits corresponding to MPDUs with Sequence Number subfield values from WinEnd_{R}+1 to ( [symbol] )SN+FN−1.
   ii) Set WinStart_{R}=( [symbol] )SN+FN−WinSize_{R}+1.
   iii) Set WinEnd_{R}=( [symbol] )SN+FN.
   iv) Set to 1 the bit at position SN in the bitmap.
3) If WinStart_{R}+2¹¹≤SN<WinStart_{R}, make no changes so the record.

[symbol]

Similarly, the BAR update for scoreboard context control is shown below
2) If WinEnd_{R}<SSN<WinStart_{R}+2¹¹.
   i) Set WinStart_{R}=SSN.
   ii) Set WinEnd_{R}=WinStart_{R}+WinSize_{R}−1.
   iii) Set to 0 bits the corresponding to MPDU with Sequence Number subfield values from WinStart_{R} to WinEnd_{R}.
3) If WinStart_{R}+2¹¹≤SSN≤WinStart_{R}, make no changes to the record.

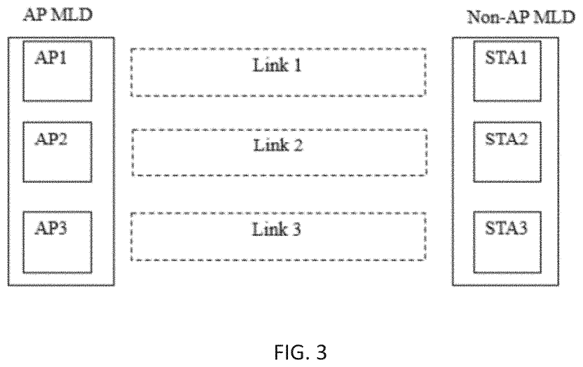

For multi-link operation, framework is to define multi-link device that includes STAs to establish links with another MLD as shown in FIG. 3.

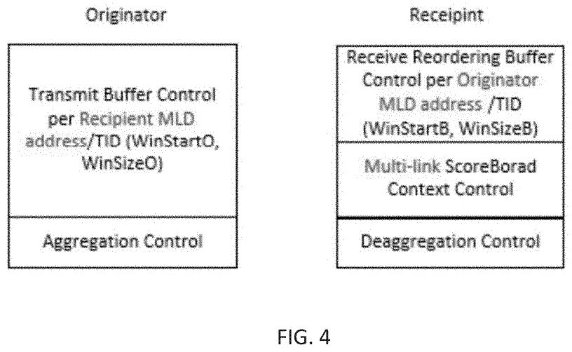

The block ack agreement between two MLDs is likely to follow the legacy block ack agreement architecture, where there is one transmit buffer control for a recipient MLD, and one receive reordering buffer control for originator MLD (see FIG 4).

Multi-link operation can enable two MLDs to transmit traffic of a specific TID on say two links simultaneously. As a result, two links are aggregated as a single large pipe to transmit data (see FIG 5).

Depending on the architecture, there can be multiple ways to achieve this implementation.

One queue implementation:

One transmission queue is implemented by the originator. Whenever a link is available, the originator can transmit the MPDU right away in the available.

Two queues implementation:

Separate transmission queues are implemented by the originator. Assume two links, then there are two transmission queues, one for each link. Once a MPDU is put in a transmission queue of a link, then it stays there until it can be moved to the transmission queue of another link. Depending on the implementation, there could be a processing time associated with moving the MPDU from one transmission queue to another transmission queue.

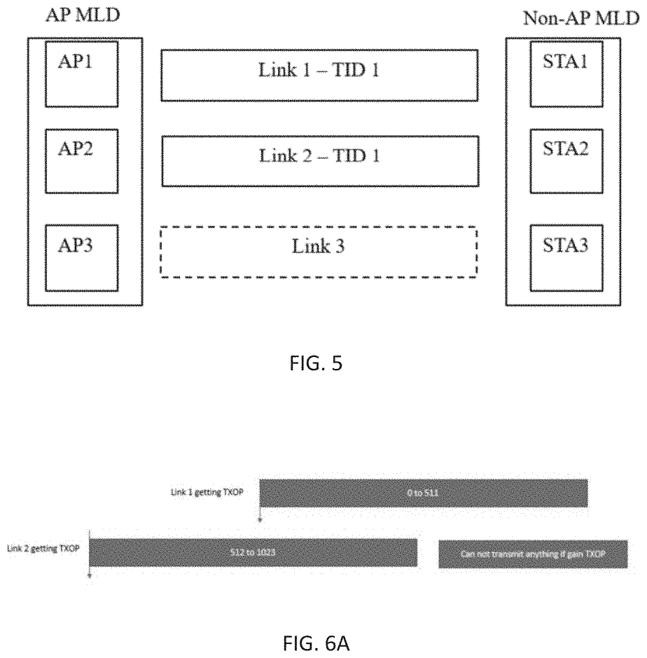

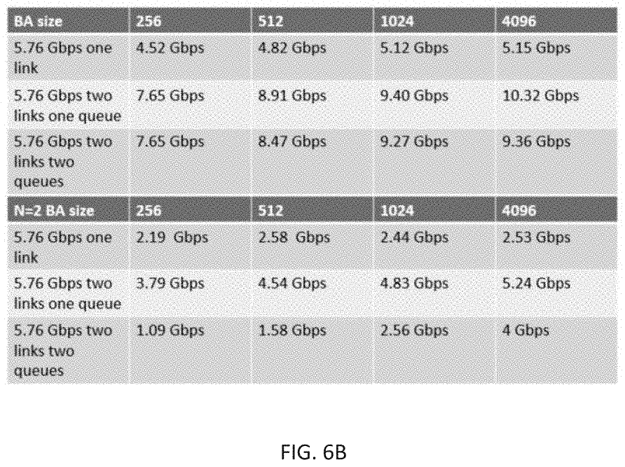

One queue implementation intuitively performs better than the two-queue implementation because it can always preserve the FIFO ability by transmitting the MPDU with smallest sequence number first, which enables earlier time to move the receive reordering buffer window. Performance of Two queue implementation may approach the performance of one queue implementation when the delay of moving MPDU among queues is small. An example is provided below to show that if MPDUs are not moved property, then certain link may not be able to transmit when it gets the chances under aggregation scenario (see FIG. 6A).

There has been discussion on the largest buffer size that can be negotiated among two MLDs or two EHT STAs. The buffer size that are under discussion are 512, 1024, 2048, and 4096. Note that the current largest buffer size supported by 11ax is 256.

One or more simulations have shown that under one link operation or multi-link aggregation with one queue implementation, then 512/1024 BA size is enough to get most of the gains. However, for multi-link aggregation with two queue implementation. Assume that the MPDUs is not moved between queues, and there is another wireless station contending for each link (N=2), then one will need larger BA buffer size like 4096 to compensate for the loss of FIFO property. The intuition is that during the time period that one cannot transmit anything due to constraint of BA window, a large BA buffer window can enable more transmissions and increases the overall throughput (see FIG. 6B).

However, a larger buffer size like 2048 and 4096 may not be supported by the current SN space range. Specifically, only 12 bits are available for the indication of SN. As a result, if one wants to have buffer size of 2048, one only has range of 2048 left for discarding range and moving range. If one wants to have buffer size of 4096, one has no range left for discarding range and moving range. One can potentially enlarge the SN space range by adding more bits, but the rule of the discarding range and moving range needs to be addressed as well.

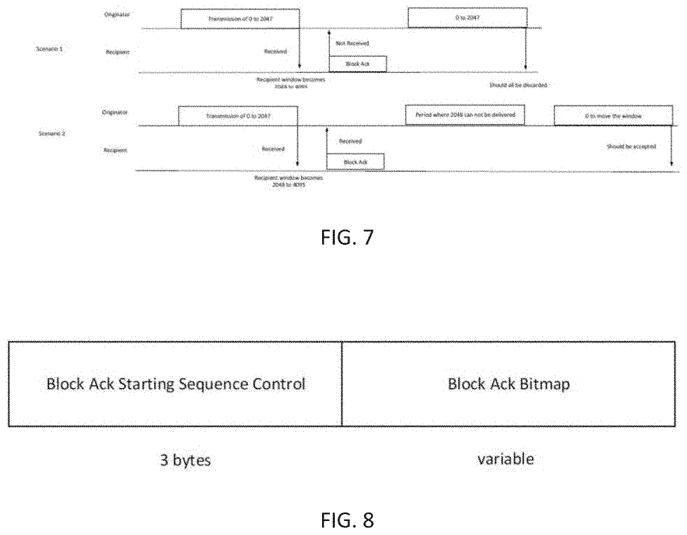

Consider the example where there is a buffer size of 2048 and a SN range of 4096. As can be seen in the following scenario 1 and scenario 2, after receiving 0 to 2047, receive reordering window moves to 2048 (WinStartB) to 4095. However, recipient does not know if Block Ack is received by the originator. As a result, in scenario 1, where block ack is not received by the originator, a retransmission of 0 to 2047 needs to be all discarded by the recipient. This implies that discarding range is also 2048. On the other hand, in scenario 2, where block ack is received by the originator, an additional transmission of SN 0 may be used to move the receive reordering buffer, which implies that at least some range for moving window is needed, which is now not supported (see FIG. 7).

In one or more embodiments, an enhanced BA window and SN range system may facilitate that the SN range needs to be larger than 2*WinSizeB, which is the smaller of the BitmapLength, i.e., the maximum block ack bitmap of a negotiated buffer size and negotiated buffer size of a block ack agreement.

A refined rule is that SN range needs to be at least 3*WinSizeB, i.e., 0<=SN<3*WinSizeB

Define the range of discarding MPDUs in receive reordering buffer as WinStartB−WinSizeB<=SN<WinStartB (operation consider modulo maximum value of SN+1)

Define the range of updating receive reordering buffer beyond WinEndB as WinEndB<SN<Win$tartB−WinSizeB (operation consider modulo maximum value of SN+1)

Define the range of ignoring BAR receive reordering buffer update as WinStartB−WinSizeB<=SSN<=WinStartB (operation consider modulo maximum value of SN+1).

Define the range of updating receive reordering buffer based on BAR as WinStartB<SSN<WinStartB−WinSizeB (operation consider modulo maximum value of SN+1).

Define the range of ignoring Scoreboard context update during full-state operation when receiving a MPDU as WinStartR−WinSizeR<=SN<WinStartR (operation consider modulo maximum value of SN+1).

Define the range of updating Scoreboard context during full-state operation when receiving a MPDU with SN beyond WinEndR as WinEndR<SN<WinStartR−WinSizeR (operation consider modulo maximum value of SN+1).

Define the range of ignoring Scoreboard context update during full-state operation when receiving a BAR as WinStartB−WinSizeB<=SSN<=WinStartB (operation consider modulo maximum value of SN+1).

Define the range of updating Scoreboard context during full-state operation when receiving a BAR as WinEndR<SSN<WinStartR−WinSizeR (operation consider modulo maximum value of SN+1).

For a maximum negotiated buffer size Y, and maximum block ack bitmap size X, where Y<=X, having at least max (12, ceil(log 2(Y*3))) bits to indicate SN.

In one or more embodiments, the detailed signaling is introduced below.

Originator and recipient negotiate the number of SN bits to be used:

The number of SN bits to be used can be implicitly decided by the buffer size that is negotiated.

For example, if buffer size Y is negotiated, then the number of SN bits is max (12, ceil (log 2(Y*3))).

When the maximum negotiated buffer size is limited by 4096, one only needs additional two bits. When the maximum negotiated buffer size is limited by 2048, one only needs additional one bit.

The bit that is reused for the extension of SN can be the retry bit in frame control.

The bit that is reused for the extension of SN can be some of the FN bit in sequence control.

Increasing the SN range will need a new compressed BA and Multi-STA BA. Detailed signaling are proposed below (see FIG. 8).

In one or more embodiments, the enhanced BA window and SN range system may facilitate the new compressed BA format as shown below to indicate different BA bitmap size. Note that Block Ack Starting Sequence Control is extended from 2 bytes to 3 bytes.

The new compressed BA can be a new variant for compressed BA or just use the existing compressed BA variant, but originator and recipient agrees to use a new format for a TID.

The new Multi-STA BA can be a new variant for Multi-STA BA that extends Block Ack Starting Sequence Control extends from 2 bytes to 3 bytes.

Having separate indication if 2 bytes is used or 3 bytes is used.

In the Block Ack Starting Sequence control, the following fields are proposed:

Starting sequence number (same number of bits used for SN).

The bit location of Starting sequence number can be from B23 to B23−X+1, where X is the number of bits of SN.

Size of Block Ack bitmap.

Separate entry for 64, 128, 256, 512, 1024, 2048, 4096.

Each entry represents (indicated value)*granularity, where the granularity can be negotiated or a fixed value like 64.

Scale of block Ack bitmap.

Indicate if all the size is scaled by a factor say 4 due to fragmentation operation.

Increasing the SN range will need a new of BAR format for compressed BA. Detailed signaling are proposed below.

The new BAR for compressed BA can be a new variant of BAR for compressed BA or the new BAR format for compressed BA can just use the existing BAR variant for compressed BA, but originator and recipient agree to use a new format.

Say two bits of FN is used for the additional sequence number.

Extend the Block Ack Starting Sequence Control of BAR information of new variable of BAR from 2 bytes to 3 bytes.

In the Block Ack Starting Sequence control, the following fields are proposed:

Starting sequence number (same number of bits used for SN)

The bit location of Starting sequence number can be from B23 to B23−X+1, where X is the number of bits of SN.

Increasing the SN range will need a new variant of Multi-TID BAR or redefine multi-TID BAR

While redefining multi-TID BAR, bits in FN can be used to indicate the additional sequence number range.

Extend the Block Ack Starting Sequence Control of BAR information of new variant of BAR from 2 bytes to 3 bytes

In the Block Ack Starting Sequence control, we propose the following fields

Starting sequence number (same number of bits used for SN)

The bit location of Starting sequence number can be from B23 to B23−X+1, where X is the number of bits of SN

One bit in the reserved field of Per TID Info of new variant of Multi-TID BAR to indicate if 2 bytes is used or 3 bytes is used.

Increasing the SN range will need a new variant of BAR for MU-BAR.

BAR control can indicate the new variant of compressed BAR or multi-TID BAR

Extend the Block Ack Starting Sequence Control of BAR information of new variant of BAR from 2 bytes to 3 bytes.

Having separate indication if 2 bytes is used or 3 bytes is used for Block Ack Starting Sequence Control. It is understood that the above descriptions are for purposes of illustration and are not meant to be limiting.

In some embodiments, a physical layer protocol data unit may be a physical layer conformance procedure (PLCP) protocol data unit (PPDU) In some embodiments, the AP and STAs may communicate in accordance with one of the IEEE 802.11 standards. IEEE draft specification IEEE P802.11.ax/D4.0, February 2019 is incorporated herein by reference in its entirety. In some embodiments, the AP and STAs may be directional multi-gigabit (DMG) STAs or enhanced DMG (EDMG) STAs configured to communicate in accordance with IEEE 802.11ad standard or IEEE draft specification IEEE P802.11ay, February 2019, which is incorporated herein by reference.

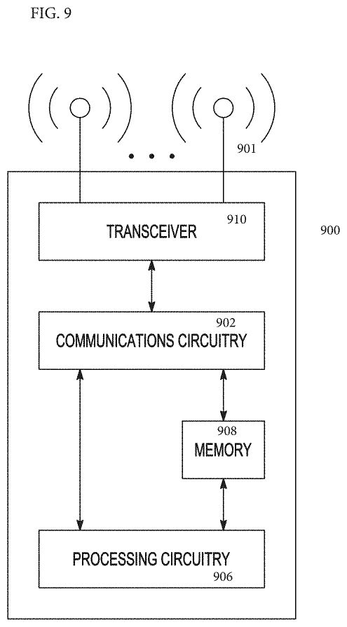

In one embodiment, FIG. 9 illustrates a functional block diagram of a communication station that may be suitable for use as an AP or a STA in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer (PHY) communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in the above figures, diagrams, and flows.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and. combinations of various hardware and logic circuitry for performing at least the functions described herein. In some embodiments, the functional elements of the communication station 900 may refer to one or more processes operating on one or more processing elements.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an extremely high throughput (EHT) device configured for operation in an EHT network, the apparatus comprising: processing circuitry; and memory,
the processing circuitry is configured to:
negotiate a block acknowledge (ACK) (BA) agreement with another EHT device, including negotiate a size of a receive reordering buffer to be up to one-third of sequence number (SN) space,
wherein the SN space has a predetermined maximum number of 4096 entries and is signaled by twelve bits.

2. The apparatus of claim 1, wherein when a larger reordering buffer is needed, the processing circuitry is configured to:
negotiate a larger reordering buffer size and additional SN space; and
add additional signalling bits to signal the additional SN space.

3. The apparatus of claim 2, wherein the additional signalling bits are within an expanded block ACK starting sequence number control field including an expanded starting sequence number field with a size equal to the twelve bits plus the additional signalling bits.

4. The apparatus of claim 2, wherein the additional signalling bits are within an existing block ACK starting sequence number control field including an expanded starting sequence number field with a size equal to the twelve bits plus the additional signalling bits.

5. The apparatus of claim 2, wherein for a maximum negotiated size Y of the receive reordering buffer and a maximum size X of a block ACK bitmap, where Y<=X, the processing circuitry is configured to designate at least max (12, ceil(log 2(Y*3))) bits to indicate the SN range.

6. The apparatus of claim 5, wherein the SN space comprises a sliding window in the memory corresponding to a maximum buffer size that is to include the receive reordering buffer of the negotiated size, a discard range and a moving range.

7. The apparatus of claim 6, wherein the discard range and the moving range have a size equal to the negotiated size of the receive reordering buffer.

8. The apparatus of claim 6, wherein the device is a multi-link device (MLD) and is configured for multi-link operation when two or more links are aggregated in which each of the aggregated links using a same traffic identify (TID).

9. The apparatus of claim 8, wherein when the MILD is operating as a recipient device and has negotiated the BA agreement with a originating MLD, the processing circuitry is to:
allocate a portion of the memory to the SN space;
decode received A-MPDUs from an originator device over two or more of the links, each MPDS having a sequence number (SN);
reorder the decoded MPDUs in the receive reordering buffer;
encode a block ACK bitmap for transmission to the originator device, a size of the block ACK bitmap corresponding to be up to a maximum of the size of the receive reordering buffer.

10. The apparatus of claim 7, wherein the device is a station (STA) configured to operate as a non-multi-link device (MLD).

11. A non-transitory computer-readable storage medium that stores instructions for execution by processing circuitry of a wireless communication device to configure the device to:
negotiate a block acknowledge (BA) agreement with another STA, including negotiate a size of a receive reordering buffer to be up to one-third of sequence number (SN) space,
wherein the SN space has a predetermined maximum number of 4096 entries and is signaled by twelve bits.

12. The apparatus of claim 11, wherein when a larger reordering buffer is needed, the processing circuitry is configured to:
negotiate a larger reordering buffer size and additional SN space; and
add additional signalling bits to signal the additional SN space.

13. The apparatus of claim 12, wherein the additional signalling bits are within an expanded block ACK starting sequence number control field including an expanded starting sequence number field with a size equal to the twelve bits plus the additional signalling bits.

14. The apparatus of claim 12. wherein the additional signalling bits are within an existing block ACK starting sequence number control field including an expanded starting sequence number field with a size equal to the twelve bits plus the additional signalling bits.

15. The apparatus of claim 12, wherein for a maximum negotiated size Y of the receive reordering buffer and a maximum size X of a block ACK bitmap, where Y<=X, the processing circuitry is configured to designate at least max (12, ceil(log 2(Y*3))) bits to indicate the SN range.

16. The apparatus of claim 15, wherein the SN space comprises a sliding window in the memory corresponding to a maximum buffer size that is to include the receive reordering buffer of the negotiated size, a discard range and a moving range.

17. The apparatus of claim 16, wherein the device is a multi-link device (MUD) and is configured for multi-link operation when two or more links are aggregated in which each of the aggregated links using a same traffic identify (TID).

18. The apparatus of claim 17, wherein when the MLD operating as a recipient device and has negotiated the BA agreement with a originating MLD, the processing circuitry is to:
allocate a portion of the memory to the SN space;
decode received A-MPDUs from an originator device over two or more of the links, each MPDU having a sequence number (SN);
reorder the decoded MPDUs in the receive reordering buffer;
encode a block ACK bitmap for transmission to the originator device, a size of the block ACK bitmap corresponding to be up to a maximum of the size of the receive reordering buffer.

19. An apparatus of a multi-link device (MLD) configured for operation in an extremely high throughput (EHT) network, the apparatus comprising: processing circuitry; and memory.
the processing circuitry is configured to:
configure the MLD for multi-link operation when two or more links are aggregated in which each of the aggregated links using a same traffic identify (TID), and
negotiate a block acknowledge (ACK) (BA) agreement with another MLD for the multi-link operation, including negotiate a size of a receive reordering buffer to be up to one-third of sequence number (SN) space,
wherein a predetermined size of the SN space is signaled by twelve bits and additional signalling bits to signal additional negotiated SN space.

20. The apparatus of claim 19, wherein the additional signalling bits are within an existing or expanded block ACK starting sequence number control field including an expanded starting sequence number field with a size equal to the twelve bits plus the additional signalling bits.
